(19) United States
(12) Patent Application Publication
(10) Pub. No.: US 2024/0315196 A1
(43) Pub. Date: Sep. 26, 2024

(54) MILKING DEVICE AND METHOD FOR MILKING AN ANIMAL

(71) Applicants: Christian Ørum Madsen, Kolding (DK); A4 AGRI A/S, Kolding (DK)

(72) Inventor: Jan SLAGER, Marknesse (NL)

(73) Assignees: Christian Ørum Madsen, Kolding (DK); A4 AGRI A/S, Kolding (DK)

(21) Appl. No.: 18/574,151

(22) PCT Filed: Jul. 6, 2022
(86) PCT No.: PCT/IB2022/000403

§ 371 Date: Dec. 26, 2023

(30) Foreign Application Priority Data
Jul. 6, 2021 (NL) 2028641

(51) Int. Cl. A01K 1/12; A01J 5/017

(52) U.S. Cl. CPC A01K 1/12; A01J 5/0175

(57) ABSTRACT

A milking device and method for milking an animal includes a frame; a teat cup carrier connected pivotally to the frame; a number of receiving elements arranged in or on the teat cup carrier and configured to receive teat cups to which milk hoses are connectable for the purpose of discharging milk, a guide for moving the teat cups and/or milk hoses substantially vertically downward and pivoting the teat cup carriers relative to the frame; and a cylinder comprising a teat cup end and a guide end. The teat cup end is connected operatively to the teat cup carrier, and wherein the guide end of the cylinder is arranged in, on or at the guide, wherein the milking device comprises a rest state and a milking state and is displaceable from the rest state to the milking state by the cylinder.

The present invention relates to a milking device and a method for milking an animal. The milking device relates to a frame and a teat cup carrier connected pivotally to the frame.

Milking devices are known in practice. The known milking devices comprise a milking claw to which teat cups are connected. In order to milk the animal for milking the milker must hold the milking claw with one hand and place the teat cups on the teats of the animal for milking one by one with the other hand.

A drawback of the known milking devices is that many operations are required on the part of the milker before the teat cups are positioned on the teats of the animal for milking. This has the result that the output of a milker is relatively low. The known milking devices further have the drawback that the operations are carried out by the milker in an ergonomically adverse posture.

In order to reduce some of the above stated problems milking devices are known wherein teat cups are moved upward from a position under the animal for milking. These milking devices are positioned under the ground surface, for instance a cow stall. The milking device can be moved by a drive from a position under the animal toward the udder through an opening in the ground surface, after which a milker can attach the teat cups to the teats. A drawback of such known milking devices is that the current milking devices have complex drives, making maintenance costs high.

It is an object of the present invention to obviate or at least reduce the above stated problems. It can be a particular object of the invention to provide a milking device with a simple drive.

This object is achieved with a milking device according to the invention, wherein the milking device comprises:
a frame;
a teat cup carrier connected pivotally to the frame;
a number of receiving elements arranged in or on the teat cup carrier and configured to receive teat cups to which milk hoses are connectable for the purpose of discharging milk,
a guide for moving the teat cups and/or milk hoses substantially vertically downward and pivoting the teat cup carriers relative to the frame; and
a cylinder comprising a teat cup end and a guide end, wherein the teat cup end is connected operatively to the teat cup carrier, and wherein the guide end of the cylinder is arranged in, on or at the guide,
wherein the milking device comprises a rest state and a milking state and is
displaceable from the rest state to the milking state by the cylinder.

Owing to the guide end of the cylinder, which is arranged in or on the guide, the teat cups and/or milk hoses are moved in a substantially vertical direction, at least in a downward direction, and the teat cup carrier is simultaneously rotated, by one single whole stroke of the cylinder. The guide end is preferably configured to move the teat cups and/or milk hoses in substantially vertical direction, preferably in a straight line, and to pivot the teat cup carrier relative to the frame. A simple drive of the milking device is hereby realized. A further advantage is that the danger of malfunctions of the milking device is reduced in that one single cylinder is needed for both movements. This is achieved particularly in that the guide preferably ensures that the teat cup carrier is unable to pivot until the milk hoses and/or teat cups have been taken back completely. A further advantage is that the teat cup carrier can automatically close the opening in the ground surface in the rest state by the pivoting movement of the teat cup carrier. Damage to or contamination of the teat cup carrier and/or teat cups is hereby prevented.

In the milking state the teat cups are in a state in which they can be attached or are attached to the teats of the animal for milking. In the rest state the teat cups are in a state in which they cannot be attached to the teats of the animal for milking. In the rest state the teat cups are preferably covered and can optionally be flushed.

The cylinder can be arranged in, on or at the guide directly or indirectly. In an embodiment according to the invention the guide end comprises a roll or roller which is arranged in the guide. An advantage hereof is that the resistance between the guide end and the guide is reduced, which facilitates the movement of the guide end through the guide.

In an advantageous embodiment according to the invention the guide comprises a first guide part for moving the teat cups and/or milk hoses substantially vertically, at least in a downward direction, a second guide part for pivoting the teat cup carrier relative to the frame, and a connecting part for connecting the first guide part to the second guide part.

With the first guide part for moving the teat cups and/or milk hoses in a substantially vertical direction, preferably in a straight line, and the second guide part for pivoting the teat cup carrier relative to the frame an effective guide which realizes both purposes is obtained.

The connecting part which connects the first and second guide part to each other is preferably a curved connection. Owing to the curvature of the connecting part it is realized that the orientations of the first and second guide part are not parallel, whereby the first and second guide part provide for different effects, i.e. substantially vertical movement of, for instance retracting of the teat cups and/or milk hoses in a substantially downward direction, and pivoting of the teat cup carrier.

In an embodiment according to the invention the cylinder comprises milk hose co-displacing elements for co-displacing the milk hoses during movement through the first guide part.

An advantage of the milk hose co-displacing elements is that the teat cups are moved toward the receiving elements, and are preferably placed therein, by the co-displacement of the milk hoses during the movement through the first guide part. The co-displacement of the milk hoses by the milk hose co-displacing elements displaces the teat cups vertically such that they are automatically placed into the receiving elements. This prevents the milker from having to disconnect the teat cups and place them in the receiving elements him/herself. A further advantage is that the milk hoses are pulled taut, whereby kinking thereof is prevented. This reduces the chance of damage to the milk hoses.

In an embodiment according to the invention the first guide part is positioned above a second guide part in use.

By positioning the first guide part above the second guide part it is realized that first milk hoses are co-displaced and the teat cup carrier is then rotated or pivoted. It is thus prevented that the teat cup carrier pivots before the teat cups have been placed in the receiving elements.

In an embodiment according to the invention the first guide part has a directional component in a substantially vertical direction, and the second guide part has a directional component in a substantially horizontal direction, and wherein the connecting part comprises a curved guide part.

The teat cups and/or milk hoses are co-displaced in substantially vertical direction due to the substantially vertical directional component of the first guide part. The substantially horizontal directional component of the second guide part realizes an effective pivoting movement of the teat cup carrier about its pivot shaft.

In an embodiment according to the invention the curvature of the connecting part between the first and second guide part lies between 20°-150°, preferably between 50°-120°, and is most preferably between 80°-100°.

Owing to said curvature, the guide end can be moved from the first guide part to the second guide part and vice versa in effective manner by the guide.

In an embodiment according to the invention the milking device further comprises a pivot shaft arranged between the frame and the teat cup carrier and situated under a ground surface for supporting the animal for milking, and wherein the teat cup carrier is positioned substantially above the pivot shaft in use.

The pivot shaft can for instance take the form of a cylindrical bush which is provided in a bearing. Owing to the pivot shaft which is positioned under the ground surface and the teat cup carrier which is positioned above the pivot shaft, the teat cup carrier can be pivoted over the pivot shaft in simple manner by a lateral movement of the teat cup end of the cylinder.

In an embodiment according to the invention the teat cups are positioned under the ground surface in the rest state and are positioned at least partially above the ground surface in the milking state, wherein the milking device can be moved from the rest state to the milking state by means of a pivoting movement over the pivot shaft.

In the rest state the teat cup carrier closes the ground surface wholly. Owing to the tilting movement which is driven in that the guide end of the cylinder moves through the second guide part, the milking device can be moved from the rest state to the milking state and vice versa. Because the teat cups are positioned under the ground surface, the teat cups are protected against dirt and/or damage when they are not in use for milking. The positioning above the ground surface in the milking state enables the milker to connect the teat cups to the teats of the animal for milking in simple manner.

In an embodiment according to the invention the guide comprises at a first position a recess for allowing clearance of the guide end of the cylinder.

The clearance of the guide end in the recess preferably extends in horizontal direction, i.e. parallel to the ground surface. The first position is preferably in the first guide part. In the milking state the guide end of the cylinder is situated in the recess. Owing to the recess the guide end can move in a substantially horizontal direction, whereby the teat cup carrier can pivot about the pivot axis. An advantage hereof is that, when the animal for milking is not positioned directly above the teat cup carrier, the teat cup carrier can tilt to the position of the animal for milking. A further advantage is that, when the teat cups are connected to the teats of the animal for milking and the animal for milking moves, the teat cup carrier can tilt along with the movement of the animal. This reduces the chance of injuries to the animal, and increases the welfare of the animal during milking.

In an embodiment according to the invention the milking device further comprises a balancing element which is operatively connected to the pivot shaft.

The balancing element can for instance be a counterweight or a spring element. The balancing means is configured to hold the teat cup carrier in position when the milking device is in the milking state and the guide end is positioned in the recess. With the balancing means the teat cup carrier is prevented from tilting wholly to one direction in that teat cup carrier is balanced. The teat cup carrier hereby remains positioned in the direction of the teat cup when connected to the teats of the animal for milking, so that no lateral force is being exerted on the milk hoses. This reduces the chance of damage to the teat cup carrier, the teat cups and/or the milk hoses.

In an embodiment according to the invention the balancing element comprises a counterweight.

An advantage of the counterweight is that a counterweight experiences no loss of opposing force over time. This increases the lifespan of the milking device.

In an embodiment according to the invention the first guide part is arranged at a guide angle to a vertical plane.

The vertical plane extends substantially perpendicularly relative to the ground surface on which the animal for milking stands. By arranging the first guide part at a guide angle a more compact milking device is obtained. This reduces the space taken up by the milking device, which saves costs when building a milking parlour.

In an embodiment according to the invention the guide angle lies in the range of 5°-45°, preferably in the range of 10°-35°, and most preferably in the range of 15°-25°.

With the above stated guide angles a compact milking device is realized.

In an embodiment according to the invention the milking device further comprises a number of milk hose guides for guiding the milk hoses, wherein the milk hose guides are positioned substantially vertically under the receiving elements.

If the cylinder is positioned at a guide angle, the milk hose guides ensure that the teat cups and/or the milk hoses are pulled substantially vertically downward. This prevents damage to the teat cups and/or the milk hoses.

In an embodiment according to the invention at least one of the number of receiving elements is provided with sensors for determining the position of the teat cup.

The sensors preferably comprise an induction sensor positioned on, at or close to the receiving element and a metal element, for instance a plate or ring, which is provided in, on or at the teat cup. By determining the position of the teat cup a vacuum can automatically be created in the milk hoses at the moment that the teat cups are removed from the receiving elements. This increases the milking speed, which reduces the total milking time and therefore reduces labour costs.

In an embodiment according to the invention the milking device further comprises a flushing device, wherein the teat cups are directed toward or at the flushing device in the rest state.

In the rest state the teat cups are preferably positioned against the flushing device. With the flushing device the teat cups can be automatically cleaned in the rest state, whereby the milker need not place the teat cups in flushing supports of the flushing device manually. This increases the ease of use. This additionally improves the hygiene of the milking device.

In an embodiment according to the invention the flushing device comprises a spring element for biasing the flushing device in the direction of the teat cup carrier.

Biasing the flushing device ensures that if the teat cup carrier pivots in the rest state, the flushing device is positioned against the teat cups. An advantage hereof is a more effective cleaning of the teat cups.

In an embodiment according to the invention the flushing device has a number of flushing outlets positioned at an angle to a flushing plane of the flushing device.

Placing the flushing outlets at an angle to a flushing plane ensures that cleaning also takes place under the edge of a teat cup mouth of the teat cup. This reduces the chance of infection of the teats of the animals for milking.

The invention further relates to a milking parlour provided with a milking device according to any one of the above described embodiments.

The milking parlour provides similar advantages and effects as described for the milking device.

The invention further also relates to a method for milking an animal, the method comprising the steps of:
providing a milking device in an embodiment according to the invention, wherein the milking device is in the rest state;
moving the guide end of the cylinder through the second guide part so that the teat cup carrier is pivoted relative to the frame;
moving the guide end of the cylinder through the first guide part so that the cylinder releases the teat cups and/or milk hoses, wherein the milking device is moved into the milking state;
arranging the teat cups on teats of the animal for milking; and
milking the animal for milking.

The method provides similar advantages and effects as described for the milking device and/or the milking parlour.

In an embodiment according to the invention the method further comprises the steps of:
releasing a vacuum from the teat cups;
moving the guide end of the cylinder through the first guide part for the purpose of taking back the milk hoses, whereby the teat cups are removed from the teats of the animal for milking; and
moving the guide end of the cylinder through the second guide part so that the teat cup carrier is pivoted relative to the frame, wherein the milking device is moved into the rest state.

Further features, advantages and details of the invention are described on the basis of embodiments thereof, wherein reference is made to the accompanying drawings, in which:

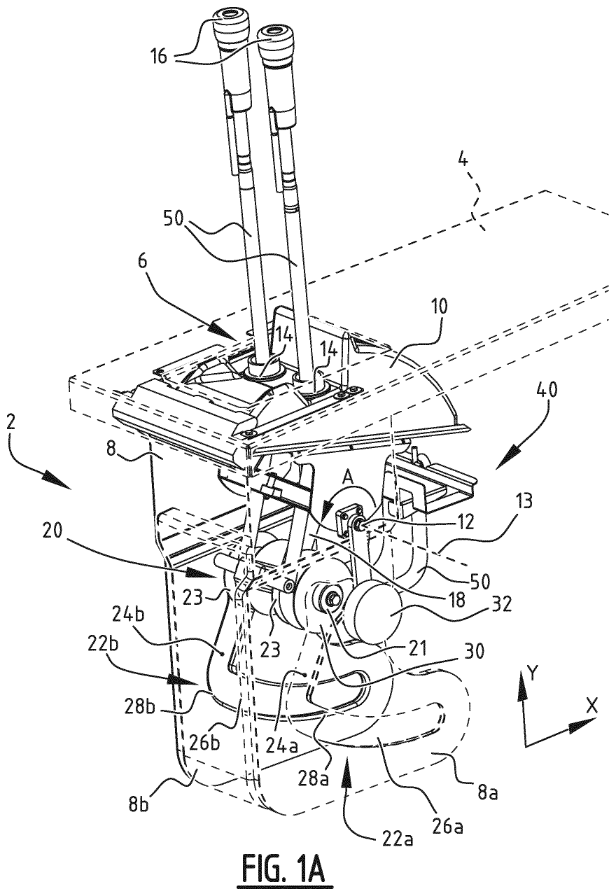

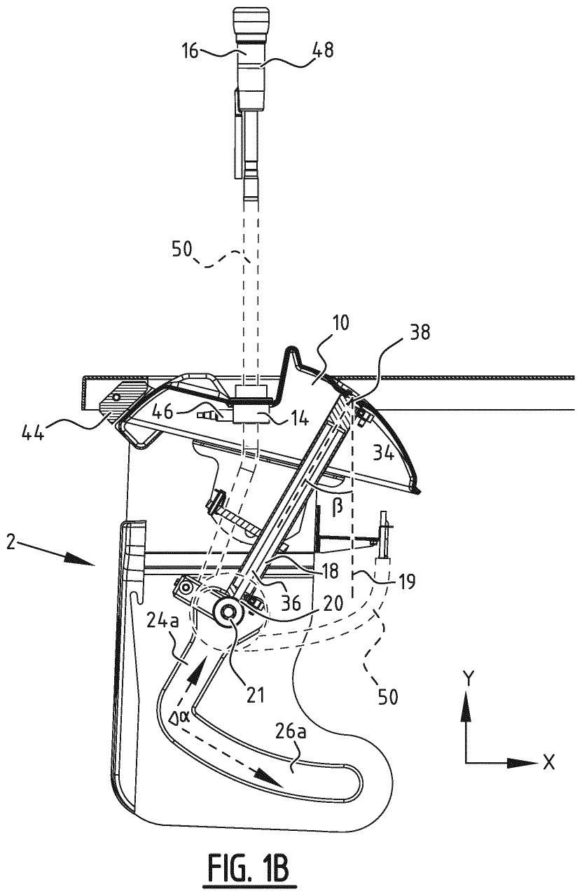

FIGS. 1A-B are a perspective view and side view of a milking device in the milking state;

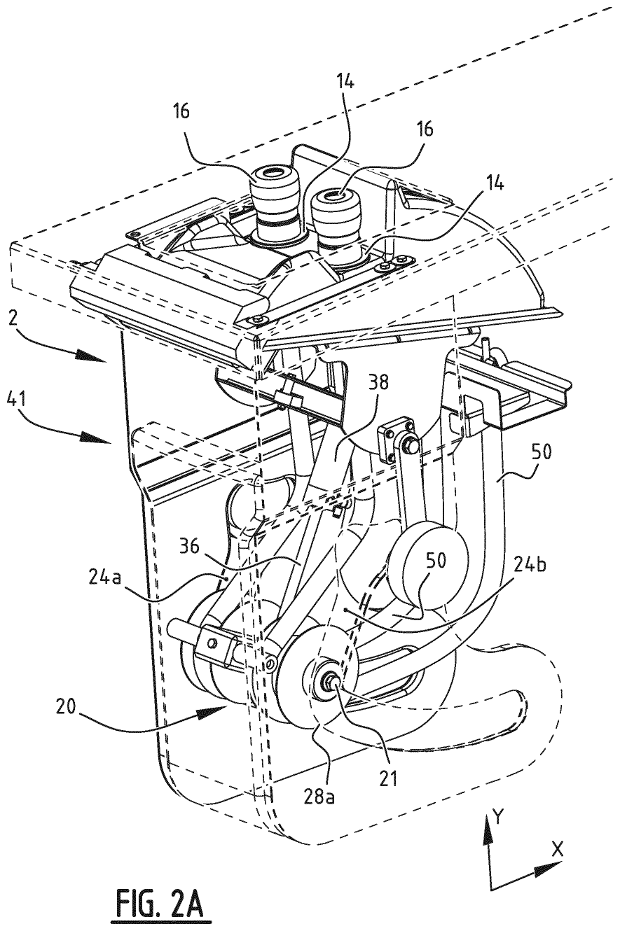

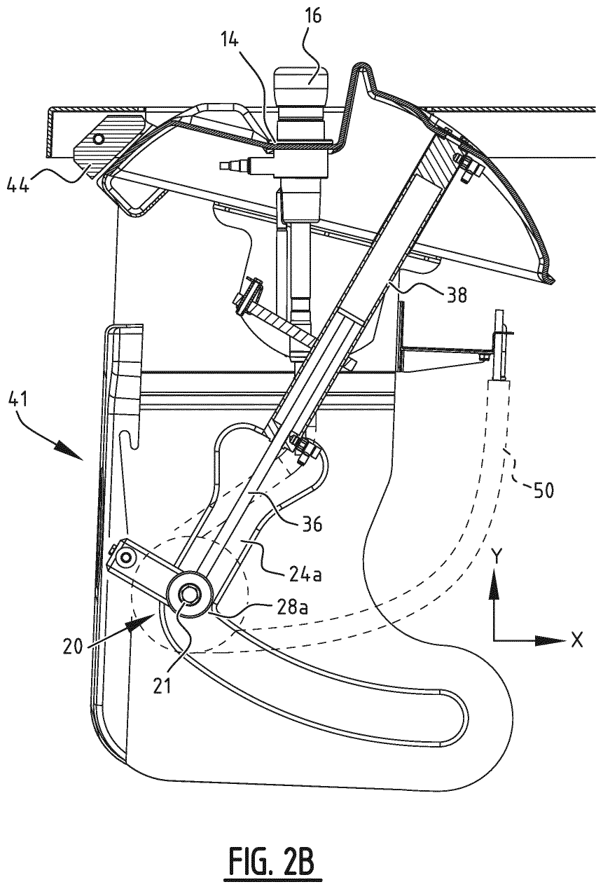

FIGS. 2A-B are a perspective view and side view of a milking device in the intermediate state; and

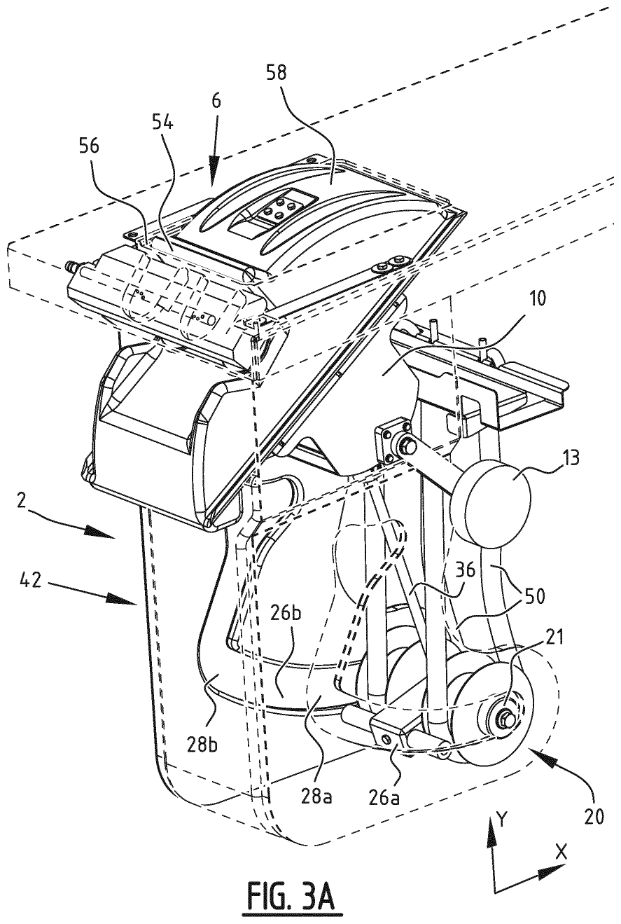

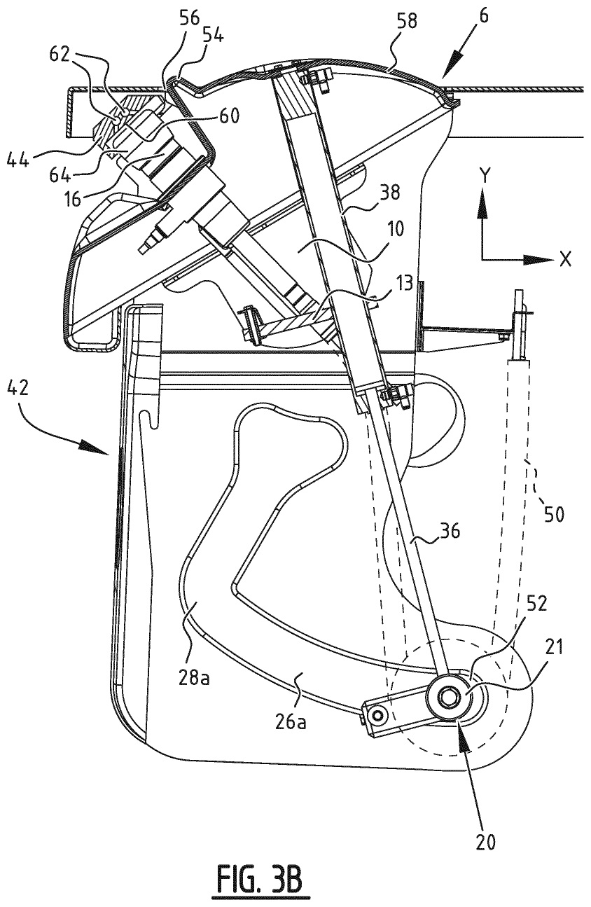

FIGS. 3A-B are a perspective view and side view of a milking device in the rest state.

Milking device 2 (FIG. 1A) is provided in ground surface 4. Ground surface 4 is configured to support the animals for milking, for instance goats. Opening 6 is provided in ground surface 4. Frame 8 of milking device 2 is arranged in opening 6. Frame 8 comprises two vertically extending plates 8a, 8b. Teat cup carrier 10 is connected pivotally to frame 8 by means of pivoting connection 12. Pivoting connection 12 makes teat cup carrier 10 pivotable about pivot axis 13 in direction A. In the shown embodiment teat cup carrier 10 comprises two receiving elements 14. Receiving elements 14 are configured to receive teat cups 16. Teat cups 16 can be connected to the teats of an animal for milking.

Milking device 2 further comprises cylinder 18 which is operatively connected with a teat cup end (not shown) to teat cup carrier 10. Guide end 20 is arranged in guide 22a, 22b opposite the teat cup end. In the shown embodiment guide end 20 is provided with roller 21 which is positioned in guide 22a, 22b formed as a guide groove. Guide end 20 can be moved effectively through guide 22a, 22b by roller 21. Two milk hose co-displacing elements 23 are further arranged on guide end 20 for the purpose of co-displacing the milk hoses of teat cups 16. Guide 22a, 22b is arranged in extending plates 8a, 8b. Guide 22a, 22b comprises first guide part 24a, 24b, second guide part 26a, 26b and connecting part 28a, 28b. First guide part 24a, 24b extends partially in a substantially vertical direction Y and is configured to move guide part 24a, 24b in a substantially vertical direction Y when cylinder 18 extends or retracts. Second guide part 26a, 26b extends partially in a substantially horizontal direction X and is configured to move guide part 24a, 24b in a substantially horizontal direction X when cylinder 18 extends or retracts.

First guide part 24a, 24b comprises recess 30 on its upper side. Recess 30 is a widened portion of first guide part 24a, 24b. Recess 30 allows guide end 20 to move in horizontal direction X at the moment that milking device 2 is in milking state 40. Downward directed counterweight 32 is further connected to pivoting connection 12. Counterweight 32 is configured to prevent undesired tilting of teat cup carrier 10 about pivot axis 13 when milking device 2 is in milking state 40.

Cylinder 18 (FIG. 1B) comprises housing 34 in which is arranged piston 36 which is movable in the housing. Also shown in FIG. 1B is teat cup end 38 of cylinder 18, wherein teat cup end 38 is connected to teat cup carrier 10. Mounted on guide end 20 of piston 36 is roller 21. Milking device 2 further comprises flushing device 44. First guide part 24a extends in direction B. Second guide part 26a extends in direction C. The angle α between first guide part 24a and second guide part 26a, i.e. the angle between direction B and direction C, is about 50° in the shown embodiment. Cylinder 18 is further placed at a guide angle ß relative to vertical direction 19. Guide angle β is about 30° in the shown embodiment. Arranged on receiving element 14 is induction sensor 46, which generates a signal when metal element 48 arranged on teat cup 16 is non-adjacent to induction sensor 46. The position of teat cup 16 can hereby be effectively determined.

Piston 36 (FIGS. 2A-B) can extend such that guide end 20 of cylinder 18 has moved through first guide part 24a, 24b and is positioned in connecting part 28a, 28b. Owing to the movement of guide end 20 to connecting part 28a, 28b, milk hoses 50 are co-displaced substantially downward in vertical direction Y by milk hose co-displacing elements 23. By co-displacing milk hoses 50 in downward direction the teat cups 16 connected to milk hoses 50 are automatically moved downward and received in receiving elements 14. In FIGS. 2A-B milking device 2 is in intermediate state 41, wherein intermediate state 41 is a transitional state between milking state 40 and rest state 42.

Guide end 20 (FIGS. 3A-B) of milking device 2 is positioned at end position 52 of second guide part 26a, 26b, whereby milking device 2 is in rest state 42. Second guide part 26a, 26b extends at least partially in horizontal direction X, whereby pivot axis 13 is situated between connecting part 28a, 28b and end position 52 as seen in horizontal direction X. Teat cup carrier 10 is hereby pivoted about pivot axis 13 in milking state 42. In rest state 42 piston 36 has performed its maximum stroke and is thus fully extended. Due to the pivoting of teat cup carrier 10, ridge 54 has been arranged against side edge 56 of opening 6. Cover 58 of teat cup carrier 10 hereby closes opening 6, whereby contamination of teat cups 16 in rest state 42 is prevented. In rest state 42 teat cups 16 are positioned against flushing device 44. Flushing device 44 is embodied here as a flat plate 60 in which flushing outlets 62 are arranged. Flushing outlets 62 are provided at an angle relative to the normal of flat plate 60, this enabling effective flushing under the edge of teat mouth 64.

In an embodiment according to the invention milking device 2 is in rest state 42 when the milking process starts, wherein guide end 20 is in end position 52 of second guide part 26a, 26b. Piston 36 is in wholly extended state, whereby guide end 20 is furthest removed from housing 34. Piston 36 is then retracted into housing 34, whereby rollers 21 of guide end 20 are moved through second guide part 26a, 26b in horizontal direction X. Teat cup carrier 10 is pivoted over pivot axis 13 by the horizontal movement of guide end 20 and the operative connection between teat cup end 38 and teat cup carrier 10. When guide end 20 is positioned in connecting part 28a, 28b and milking device 2 is in intermediate state 41, teat cup carrier 10 is pivoted over pivot axis 13 such that teat cups 16 are directed substantially vertically upward through opening 6 of ground surface 4.

Piston 36 can then be retracted further into housing 34 so that roller 21 of guide end 20 is moved through first guide part 24a, 24b. Milk hoses 50 are hereby released so that teat cups 16 can be arranged on the teats of the animal for milking. When guide end 20 is positioned in recess 30, milking device 2 is in milking state 40. In milking state 40 milk hoses 50 are wholly released. Recess 30 allows guide end 20 to move in horizontal direction X, whereby teat cup carrier 10 can co-displace with the movements of the animal for milking. In the shown embodiment counterweight 32 is connected to pivoting connection 12 so that teat cup carrier 10 is positioned in stable manner in any position and tilting of teat cup carrier 10 through to one side is prevented. When teat cups 16 are removed from receiving elements 14 so as to be arranged on the teats of the animal for milking, this is detected by induction sensor 46. In an advantageous embodiment of the invention a vacuum is automatically created in milk hoses 50 of teat cups 16 after removal from receiving elements 14 is detected.

After milking of the animal, teat cups 16 are removed and piston 36 extends from housing 38, whereby guide end 20 moves through first guide part 24a, 24b and milk hoses 50 are co-displaced by milk hose co-displacing elements 23, whereby teat cups 16 are placed into receiving elements 14. After guide end 20 has been moved through first guide part 24a, 24b and is situated in connecting part 28a, 28b, guide end 20 is moved through second guide part 26a, 26b. During the movement of guide end 20 through second guide part 26a, 26b teat cup carrier 10 is tilted over pivot axis 13. Ridge 54 hereby falls onto side edge 56 of opening 6. When guide end 20 is positioned at end position 52, milking device 2 is in rest state 42. In rest state 42 teat cups 16 are tilted against flat plate 60 of flushing device 44, after which teat mouths 65 of teat cups 16 can be flushed effectively by flushing outlets 62.

The present invention is by no means limited to the above described embodiments thereof. The rights sought are defined by the following claims, within the scope of which many modifications can be envisaged.

1. A milking device, comprising:
a frame;
a teat cup carrier connected pivotally to the frame;
a number of receiving elements arranged in or on the teat cup carrier and configured to receive teat cups to which milk hoses are connectable for the purpose of discharging milk,
a guide for moving the teat cups and/or milk hoses substantially vertically downward and pivoting the teat cup carriers relative to the frame; and
a cylinder comprising a teat cup end and a guide end, wherein the teat cup end is connected operatively to the teat cup carrier, and wherein the guide end of the cylinder is arranged in, on or at the guide,
wherein the milking device comprises a rest state and a milking state and is displaceable from the rest state to the milking state by the cylinder.

2. The milking device according to claim 1, wherein the guide comprises a first guide part for moving the teat cups and/or milk hoses substantially vertically, a second guide part for pivoting the teat cup carrier relative to the frame, and a connecting part for connecting the first guide part to the second guide part.

3. The milking device according to claim 1, wherein the cylinder comprises milk hose co displacing elements for co-displacing the milk hoses during movement through the first guide part.

4. The milking device according to claim 1, wherein the first guide part is positioned above a second guide part in use.

5. The milking device according to claim 1, wherein the first guide part has a directional component in a substantially vertical direction, wherein the second guide part has a directional component in a substantially horizontal direction, and wherein the connecting part comprises a curved guide part.

6. The milking device according to claim 5, wherein the curvature of the connecting part between the first and second guide part lies between 20°-150°.

7. The milking device according to claim 1, further comprising a pivot shaft arranged between the frame and the teat cup carrier and situated under a ground surface for supporting the animal for milking, and wherein the teat cup carrier is positioned substantially above the pivot shaft in use.

8. The milking device according to claim 6, wherein the teat cups are positioned under the ground surface in the rest state and are positioned at least partially above the ground surface in the milking state, wherein the milking device can be moved from the rest state to the milking state by means of a tilting movement over the pivot shaft.

9. The milking device according to claim 1, wherein the guide comprises at a first position a recess for allowing clearance of the guide end of the cylinder.

10. The milking device according to claim 7, further comprising a balancing element which is operatively connected to the pivot shaft.

11. The milking device according to claim 10, wherein the balancing element comprises a counterweight.

12. The milking device according to claim 1, wherein the first guide part is arranged at a guide angle to a vertical plane.

13. The milking device according to claim 12, wherein the guide angle lies in the range of 5°-45°.

14. The milking device according to claim 1, further comprising a number of milk hose guides for guiding the milk hoses, wherein the milk hose guides are positioned substantially vertically under the receiving elements.

15. The milking device according to claim 1, wherein at least one of the number of receiving elements is provided with sensors for determining the position of the teat cup.

16. The milking device according to claim 1, further comprising a flushing device, wherein the teat cups are directed toward or at the flushing device in the rest state.

17. The milking device according to claim 16, wherein the flushing device comprises a spring element for biasing the flushing device in the direction of the teat cup carrier, and wherein the flushing device has a number of flushing outlets positioned at an angle to a flushing plane of the flushing device.

18. (canceled)

19. A milking parlour provided with a milking device comprising:
a frame;
a teat cup carrier connected pivotally to the frame;
a number of the receiving elements arranged in or on the teat cup carrier and configured to receive teat cups to which milk hoses are connectable for the purpose of discharging milk,
a guide for moving the teat cups and/or milk hoses substantially vertically downward and pivoting the teat cup carriers relative to the frame; and
a cylinder comprising a teat cup end and a guide end, wherein the teat cup end is connected operatively to the teat cup carrier, and wherein the guide end of the cylinder is arranged in, on or at the guide,
wherein the milking device comprises a rest state and a milking state and is displaceable from the rest state to the milking state by the cylinder.

20. A method for milking an animal, comprising of:
providing a milking device comprising:
a frame;
a teat cup carrier connected pivotally the frame;
a number of receiving elements arranged in or on the teat cup carrier and configured to receive teat cups to which milk hoses are connectable for the purpose of discharging milk,
a guide for moving the teat cups and/or milk hoses substantially vertically downward and pivoting the teat cup carriers relative to the frame; and
a cylinder comprising a teat cup end and a guide end, wherein the teat cup end is connected operatively to the teat cup carrier, and wherein the guide end of the cylinder is arranged in, on or at the guide,
wherein the milking device comprises a rest state and a milking state and is displaceable from the rest state to the milking state by the cylinder, wherein the milking device is in the rest state;
moving the guide end of the cylinder through the second guide part so that the teat cup carrier is pivoted relative to the frame;
moving the guide end of the cylinder through the first guide part so that the cylinder releases the teat cups and/or milk hoses, wherein the milking device is moved into the milking state;
arranging the teat cups on teats of the animal for milking; and
milking the animal for milking.

21. The method according to claim 20, further comprising:
releasing a vacuum from the teat cups;
moving the guide end of the cylinder through the first guide part for the purpose of taking back the milk hoses, whereby the teat cups are removed from the teats of the animal for milking; and
moving the guide end of the cylinder through the second guide part so that the teat cup carrier is pivoted relative to the frame, wherein the milking device is moved into the rest state.
